(19) United States
(12) Patent Application Publication
(10) Pub. No.: US 2003/0233425 A1
(43) Pub. Date: Dec. 18, 2003

(54) Method and system for personal portal screen

(76) Inventors: Barry C. Lyons, New York, NY (US); Robert Gorzegno, New York, NY (US)

Correspondence Address: Steven Horowitz, Counselor At Law, 295 Madison Avenue, Suite 700, New York, NY, 10017, US

(21) Appl. No.: 10/603,268

(22) Filed: Jun. 24, 2003

Related U.S. Application Data
(63) Continuation of application No. 09/564,997, filed on May 4, 2000, now abandoned.

(51) Int. Cl. G06F 15/16

(52) U.S. Cl. 709/217

(57) ABSTRACT

Method and system of attaching URLs to mobile HTML element in graphical Internet browser environment. A personal Internet portal system features icons generated and accessible in an aesthetically appealing way linked to favorite web sites. A toolbar visual cue indicates a visited website is a system partner—that website's logo may be imported to the portal page and function as an icon-link to that website. If visited website is not a partner, icon generator generates a selection window for topics, visual images and name—the selected, named visual image, imported into the portal page, is an icon-link to the non-system partner website. System partner icon-links receive periodic marketing information as link mails. Advertisers advertise on the personal portal screen and on websites via advertising banners so users can import additional icons onto the portal page. System partner advertising icon-links are dragable into the portal screen from advertising strip or website.

The present invention is a continuation application of U.S. patent application Ser. No. 09/564997 entitled “Method and System for Personal Portal Screen” which was filed on May 4, 2000 by co-inventor, Barry C. Lyons, and which is presently pending.

The present invention relates generally to computer systems and more particularly to creating links to favorite or “bookmarked” web sites on the Internet.

It is well recognized that users of the Internet have difficulties locating and identifying web sites in the World Wide Web portion of the Internet since the World Wide Web is not centralized. Various navigation tools have been developed to help users navigating the World Wide Web.

The term “portal screen” as used herein means the opening computer screen that an Internet Service Provider or a search engine places in front of a user when the user first goes online. The personal portal screen dictates the kind of information available to the user and the options available to the user to access information and materials on the World Wide Web.

Presently, a user's favorite web sites can be bookmarked and placed in a group for easy accessibility. However, the presently known systems for providing users with groups of bookmarked web sites suffer from many drawbacks. Some of these drawbacks affect the Internet end user directly. For one thing, the existing displays of groups of favorite web sites do not exist as visually appealing customized icons, meaning visual images, but rather are simple directory-style listings consisting of the electronic addresses of the favorite web site along with the title. Secondly, the user has to go through the portal screen of the Internet service provider prior to reaching the list or grouping of the bookmarked favorite web sites. A user may not want to have to see all the marketing material and possibly offensive news and/or information dictated by the ISP.

For example, America Online's portal screen often has pop up advertising windows that precede the screen and force the user to see them. Then the portal screen usually includes photos of an attractive entertainment star and a whole listing of categories of topics. The consideration used by America Online may not be suitable for the user for two reasons. America Online considers what portal screen is most appealing to the average American that it directs its marketing to, which may not be the user. The user may have different tastes and values. Second, America Online and other such gatekeepers of the Internet try to maximize their profits by pushing the user to companies that it has a business relationship with—or at least these relationships influence the way the portal screen is structured. The result is that the user is not afforded the feeling of a customized personal portal screen fashioned by and for that user in keeping with that user's tastes and values. Moreover, the grouping of the user's favorite web sites is not immediately available to the user until the user plods through one or more other computer screens whose content is dictated by others and whose content may not suit the user's tastes and values.

A third drawback is that the bookmarked favorite web sites listed in a group cannot be moved around the screen by the user and arranged by the user however the user wishes, either when the user is online or off-line. Instead, the bookmarked favorite web sites are static, and do not share the full on screen functionality of other objects in a graphically based windowed operating system. The fact that they are static, combined with the fact that they are not image oriented but are mere listings of addresses, greatly reduces the power of their appeal.

Another type of problem existing in the current Internet environment concerns not end users directly, but advertisers. Advertisers need a way to ingratiate themselves with users of the Internet in the sense of attracting repeated visits to the advertiser's web site. Advertisers want as many users as possible to treat that advertiser as one of the user's favorite places to go visit in cyberspace. Furthermore, it would be even more helpful to be able to periodically communicate with users to update them on new offers and provide additional marketing information. This is true in regard to users who have already selected the advertiser as a favorite place to visit and it is equally true or even more true in regard to users who have to first be approached to convince that user to consider the advertiser's web site a favorite place to visit. Presently, advertisers communicate in cyberspace to prospective users by sending them electronic mail messages and by thrusting themselves in front of the user's eyes by means of pop up windows. Electronic mail messages have severe drawbacks as a form of marketing since these messages, especially when they are received periodically from a favorite merchant, have to compete with the high quantity of spam—unwanted junk electronic mail—and electronic messages are often discarded and not taken seriously as a result. In addition, pop up windows are obviously not ideal as a form of advertising since they are not expected and can be annoying.

There exist in the prior art some patents relating to Internet shortcuts to establish links to preferred web sites. For example, U.S. Pat. No. 5,877,765 to Dickman et al. teaches a Method and System for Displaying Internet Shortcut Icons but it does not disclose the visually appealing features nor does it have the other novel features of the present invention, as described in detail below, which address the above-mentioned drawbacks and advertiser concerns.

The present invention addresses and solves both of these types of problems: the need for appealing personal portal screens; and the need for a system that allows advertisers to reach users in a more appealing way. First of all, the present invention offers the most technologically advanced and aesthetically pleasing personal portal screen system for Internet users. Users can employ a method and system of setting up a customized, mobile, image-oriented, icon-based and more aesthetically appealing portal screen, which is an alternative to bookmarking web sites by address. This also eliminates the inconvenience that exists in some systems of having to scroll down a list of favorite web sites to access a particular favorite web site. Furthermore, the use of a log-in and password system enables users to access these personal portal screens from any computer that has a hook-up to the Internet. The present invention also allows users to send, via e-mail, a personal portal screen of favorite web sites to other users.

Second, the present invention allows advertisers to be part of this mobile, image-oriented, icon-based and more aesthetically appealing method and system for creating a personal portal screen of favorite web sites and favorite advertising web sites. The present invention also provides the advertisers with a way of periodically communicating to users who have selected that advertiser as a favorite advertising web site. The present invention also allows advertisers to be partners with the system without unduly interfering the appeal and advantages of the system to the user.

### IMPORTANT OBJECTS AND ADVANTAGES

The following important objects and advantages of the present invention are:

(1) to provide a method and system of creating and accessing a personal portal screen of icons or visual images having links to favorite web sites in a visually and aesthetically appealing way,

(2) to provide a method and system of creating and accessing a personal portal screen of icons in which a user creates icons for favorite web sites after downloading, rather than logging on to, a system software to a personal computer forming part of a computer system; by first selecting a topic from a first selection window, then selecting a visual image from a second selection window and then naming and confirming the icon,

(3) to provide a system and method of creating and accessing a personal portal screen of icons with links to favorite web sites in one of three different but complementary ways;

(4) to provide a method and system of creating and accessing a personal portal screen of icons with links to favorite web sites wherein a “visual cue” is given in the system toolbar to let the user know that a web site visited by the user is a system partner, and by clicking an icon generator function the logo of the web site can be imported into the personal portal area;

(5) to provide a method and system of creating and accessing a personal portal screen of icons as links to favorite web sites wherein a “visual cue” is given in the system toolbar to let the user know that a web site visited by the user is not a system partner but can still be imported into the personal portal area by clicking an icon generator to prompt a three-part selection process (selecting a topic, selecting an image/icon and confirming selection of the image/icon);

(6) to provide a method and system of creating and accessing a personal portal screen of icons with links to favorite web sites wherein having arrived at an Internet site in the usual manner the user clicks an alternative function in a tool bar that will prompt the three-part dialog box;

(7) to provide a personal portal screen made up of icons representing favorite web sites and/or favorite advertising web sites of a user that is accessible from any computer connected to the World Wide Web anywhere merely by logging in to the system site,

(8) to provide a method and a system for a personal portal screen system that allows the incorporation into the personal portal of favorite advertising web sites merely by clicking on the advertising banner for the favorite advertising web site and dragging the advertiser's associated logo into the personal portal wherein the movement of the drag prompts the portal screen until the user has placed the advertiser's icon on the personal portal screen whereupon it reverts to the web page the user was on,

(9) to provide a method and system for a personal portal screen of icons that allows the user, when visiting a system-partner web site, to drag that merchant partner's trademark/logo from a non-button portion of the system toolbar whereby the dragging prompts the personal portal screen—and once the icon has been imported into the personal portal, the screen revets back to the merchant's web site.

(10) to provide a method and system for a personal portal screen wherein the icon-links to favorite web sites are movable by the user on the portal screen.

(11) to provide a method and system for incorporating favorite advertising web sites into a personal portal screen that allows periodic communication of messages to the user from the advertiser by way of a link mail associated with the icon-logo that has been dragged into the personal portal screen,

(12) to provide such a method and system where the link mail can be expanded and forwarded to a friend or other user;

(13) to provide such a method and system where the user can be notified of the receipt of link mail by the appearance of a small visual symbol;

(14) to provide a method and system of incorporating favorite advertising web sites into a personal screen, which method involves establishing partnerships with merchants who want to promote the likelihood of placement of their site as a favorite advertising web site into the personal portal screen of a user wherein it is easier for a user to bring partners into the personal portal screen than non-partners,

(15) to provide such a method and system containing a security feature so that only registered merchant partners can be brought into the personal portal screen in the easier way;

(16) to provide such a method and system wherein the logos or icons associated with a registered merchant partner whose web site is to be in the personal portal screen have been security-cleared or approved by the system when the merchant applies to be registered as a merchant partner of the system;

(17) to provide a method and system of attaching URLs to a mobile HTML element in a graphical Internet browser environment to create aesthetically appealing visual display of favorite web sites for Internet-enabled computer, communications and entertainment devices;

(18) to provide a single page display of all of the visual images, merchant partner logos and/or advertising banners on a single page to form the personal portal screen of favorite web sites and favorite advertised web sites so that the user can see them all simultaneously;

(19) to provide a method and system that provides a single page display of all of the visual images, merchant partner logos and/or advertising banners on a single page to form the personal portal screen of favorite web sites and favorite advertised web sites so that the user can see them in a location on the screen of the user's choosing;

(20) to provide a method in which members of the system create a personal portal screen wherein the merchant partners of the system can determine what logo representing the merchant partner the members of the system would use as icon links to the merchant partner's web sites; and

(21) to provide a method of creating a personal portal screen wherein merchant partners of the system can supply logos and messages only to members of the system rather than to anyone on the world wide web.

These and other objects of the present invention will become clearer from the detailed description of the preferred embodiment and from the drawings.

### BRIEF DESCRIPTION OF THE DRAWINGS

FIG. 1 shows the first screen page of the system and method of the present invention;

FIG. 2 shows an empty screen page of the personal portal screen showing function keys and advertising;

FIG. 3 shows a screen page with the three-part dialog box opened up;

FIG. 4 shows a screen page of the personal portal screen showing one icon in accordance with the method and system of the present invention;

FIG. 5 shows a favorite web site of a user in position to be represented by an icon in accordance with the method and system of the present invention;

FIG. 6 shows a screen page with the three-part dialog box opened up with use of the icon generator while the user is already in a non-system partner favorite web site;

FIG. 7 shows a personal portal screen with icons for favorite web sites and favorite advertising web sites in accordance with the method and system of the present invention;

FIG. 8 shows a person portal screen with a favorite advertising web site containing a link mail and a “moused over” message of an advertiser in the advertising strip sidebar;

FIG. 9 shows a “before” and “after” view of the process of dragging a merchant logo out of an advertising banner on a visited web site to the personal portal screen. The advertising banner also has a visual symbol in its upper sight-hand corner indicating that the advertiser is a merchant partner. The dotted line in FIG. 9 indicates dragging movement by the user; and

FIG. 10 shows three boxes depicting a succession of views undergoing an alternative method whereby a user visiting a merchant partner web site containing a merchant partner screen can add a favorite merchant partner web site to the personal portal screen by placing a cursor on a non-button portion of the system toolbar and dragging the cursor into the merchant partner's screen; and

FIG. 11 shows a preferred embodiment of the system of the present invention.

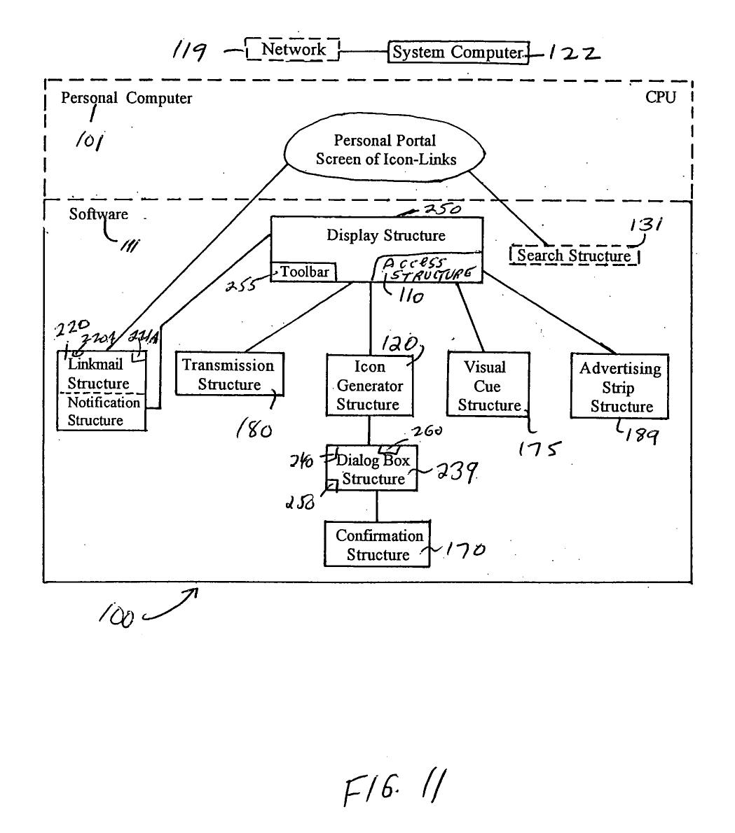

### DETAILED DESCRIPTION OF THE PREFERRED EMBODIMENT

In this patent application, an “icon” is any graphic image. Usually an icon is pictorial but an icon can also be stylized text. The icon is accessible to the computer user, for example by being clickable. The icons on the personal portal screen of the present invention are also movable at the initiative of the user. One way in which icons are movable is that the icons are dragable. “Clickable”, which is one way icons can be accessible, means that when a cursor is positioned over the icon on screen via movement of the mouse and when a secondary control on the mouse is activated, typically a button, a defined action is undertaken with respect to the object represented by the icon. For example, a “double click”, two rapid activations of a button, typically a left button on a mouse, may order an execution of a program or the opening of a file with a program. Clickable also includes a computer function that dispenses with the mouse and uses fingers or other means (such as a track ball) to move the cursor around the screen.

“Dragable”, which is one way icons can be movable, means that the icon can be repositioned about a computer screen, typically by placing a cursor over the icon on screen as controlled by the mouse or other pointing device, and then activating and holding a secondary control while repositioning the pointing device. The icon then moves in concert with the cursor on screen and is “dragged” to a new on screen location. Such movement may either be of purely aesthetic significance, grouping or arranging icons on screen according to user preferences, or else may initiate a particular function depending on a location of the icon when it is “dropped”, that is, when the dragging operation is terminated by release of the secondary control.

The term “movable” with respect to icons is broader in meaning than clicking and dragging. The present invention, however, also contemplates movable icons that are movable other than by being dragged. For example, the icons may be “hopped” to a new location on the screen whether or not there is presently software available do so. The present invention also contemplates moving icons by using other pointers such as a body portion for example a hand or finger acting as a pointer wherein the user places the hand or finger near the computer screen and moves the hand or finger to move the icon in a dragging, hopping or other motion.

A graphic or representation having the attributes of an icon or a system or software having such graphics or representations may also be described as “iconic”.

Personal computers include a mouse or other cursor positioning or pointing means for positioning a cursor or cursor equivalent on the display device. A cursor equivalent include other devices that function like a cursor.

A “system computer” in this application shall mean a computer maintained by or providing the services required to implement the centralized functions of the method and system of the present invention, meaning those functions which are not assigned to the personal computer or to a computer network intermediate between the system computer and the personal computer. The system computer will generally be equivalent to a server, the personal computer to a client, in the ordinary language of contemporary computing.

“Downloading” means a file transfer between a system computer and a personal computer, so that a file or program stored on the system computer is copied via an intervening network connection into the static or volatile memory of the personal computer. For the purposes of this application, “loading” will be understood to mean either downloading or any other means for distributing copies of a program or other data into the static memory of personal computers, including transportation and reading of physical disks, media.

When a user is said to have loaded or downloaded a program or software that user will also be understood when necessary to have installed, and when further necessary, to be running that software, or causing it to be executed on the personal computer. When a user is “at” or “visiting” a web site it will be understood that the user is operating a computer having a browser program, and that the browser program is currently displaying (or would be displaying if not minimized) an image associated with the interpretation of the file or files of that given web site.

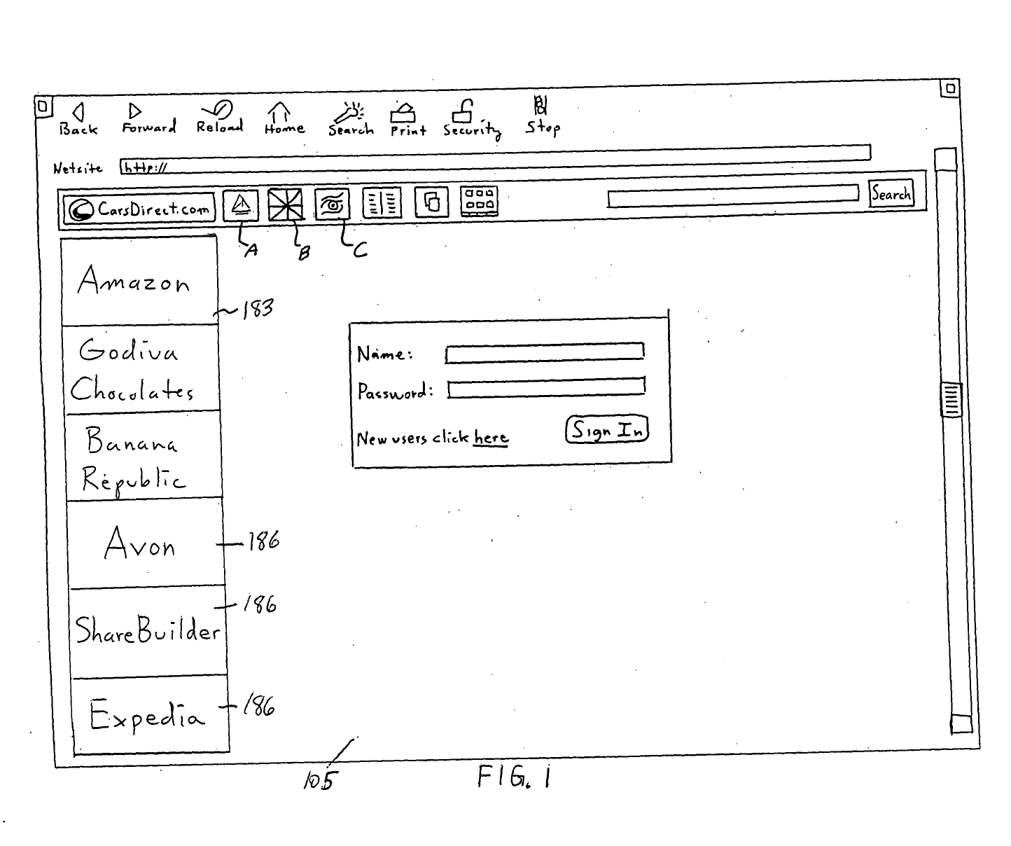

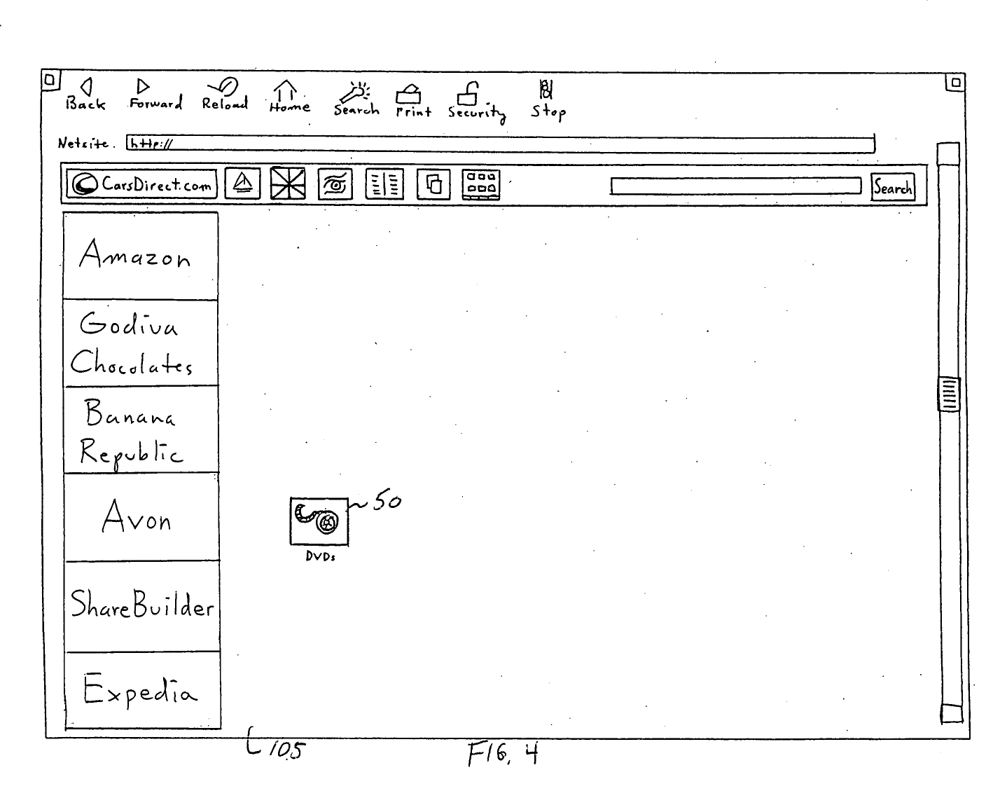

A visual step-by-step depiction of the screens seen by a user of the method of the present invention is presented in drawing FIGS. 1 through 10.

The present invention is for a personal computer coupled to a network, wherein the personal computer has an operating system that enables a web browser to locate and access a web site by a Uniform Resource Locator. The method of the present invention involves setting up an aesthetically appealing personal portal screen of bookmarked web sites that are easily accessible. While the term “bookmarked web sites” usually refers to the web address of a favorite web site, as used herein that term refers generally to any accessible representation of favorite web sites, including a representation in the form of icons or visual images. The visual images or icons may be grouped according to the preferences of a user, and will generally permit access to the represented web sites by clicking on the representations or icons of those sites. These icons representing the bookmarked web sites are capable of receiving periodic messages, for example from a merchant contacting prospective buyers.

A user of the method and system of the present invention can create a plurality of icons or visual images of the user's favorite web sites laid out on a computer screen, and grouped according to the user's preferences. The user can then access the screen having that grouping of icons from any computer anywhere that can access the World Wide Web. Once the grouping of icons has been set up, the screen of icons laid out for the user can function as the user's personal portal to the Internet. The icons on the screen are mobile—that is, they can be moved around the computer screen when the user is online, for example by dragging. The terms “mobile” and its noun form “mobility” are intended, in connection with icons, to be synonymous with the term “movable”.

Once the grouping of icons has been set up the user is presented with a computer screen filled with icons or visual representations of the user's favorite web sites and/or favorite advertising web sites. The screen of icons laid out for the user can function as the user's personal portal to the Internet.

Access to the personal portal screen referred to occurs after the user has created the personal portal screen of favorite web sites represented by icons in accordance with the method and system of the present invention. In order for the user to create such a site, the user generates icons that are links to the user's favorite site. The method differs slightly depending upon whether or not the web site that the user desires to bring into the personal portal screen as a favorite web site is a system partner, that is, a limited business partner of the system provider. A “system partner” is a concern which has entered into at least a limited agreement with the system provider in order to make their web sites especially user friendly for implementation on the personal portal of a user. A system partner is sometimes called a merchant partner. In this case, the icon is a trademark or logo associated with the merchant in question. In the other case, the user may bring in generic icons into the personal portal screen for merchants and other web sites that are not system partners, as described below.

The system provider may also be referred to as the system or plan owner, and is distinct from any Internet service provider which in turn may provide equipment or network access. The system provider is the entity administering the plan or system, and which makes special software available for download to a user, and ensures that appropriately configured servers are available to support implementation of the method and system of the invention.

The Method

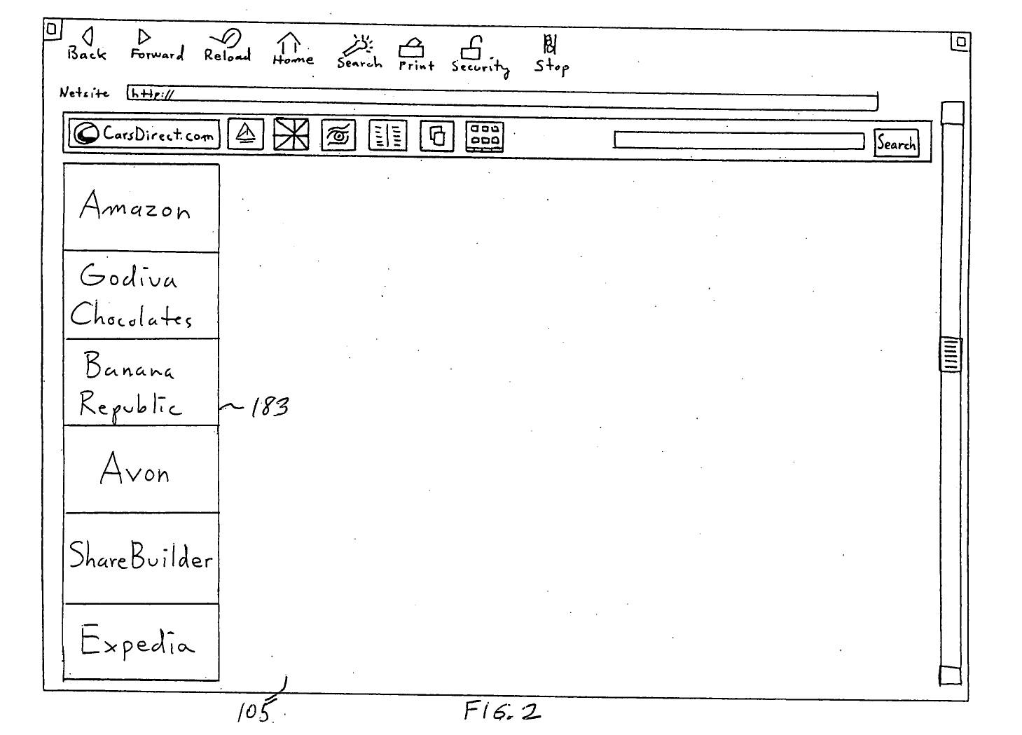

In accordance with the present invention, the user is at a web site maintained by a computer of the system provider. The method and system of the present invention works with a computer system coupled to a network where the computer system includes a personal computer having an operating system that allows a web browser to locate and access a web site via a URL. As stated, if a personal portal screen of icons has not been created yet by or for the user, as seen in FIG. 2, the user would access and see a blank personal portal screen after downloading and installing the system software. The downloaded software includes a system specific toolbar which, following installation of the software on a user's personal computer, appears on the user's computer screen whenever the user is online at any point during navigation throughout the World Wide Web including when the user is at the personal portal screen. In this case, the method for adding icons to a personal portal screen starts with going to the web site that you want to import in the personal portal screen and then clicking the icon generator function by clicking a button in the system toolbar, preferably a button containing some visual display, which is a standard “tool bar” typically located near the top or side of the computer screen. The word “standard” means that it looks similar to prior art toolbars.

The system of the present invention will have its own tool bar that would include function buttons specific to the system and method of the present invention. An example of such function button is the function button used for generating icon-links. As seen in FIG. 1, for example, six buttons appear in the system toolbar. In a preferred embodiment, the three left-most buttons are the only buttons that would appear. These include a button A that when pressed returns the user to the personal portal screen, the visual cue button B (which is really a cue and not a button to be pressed) and a third button, the icon generator button C. In the preferred embodiment, the three right-most buttons would not be on the system toolbar at all.

In the present invention, the user who wants to bring a favorite web site into the personal portal screen has already typed the URL, has hit “enter” or “return” and is already viewing that favorite web site. The user clicks an icon generator button on the downloaded system toolbar. As a result, if the web site is a system partner then a merchant's logo will pop up on the screen (typically in the center of the screen) with a prompt to import that logo into the personal portal page such as by clicking in response to the prompt (the logo brought into the personal portal screen would then represent a link to that favorite web site). If the web site is not a system partner, a three-part window, as will be described below, for the selecting and naming of generic icons will pop up on the screen. A visual cue area on the system tool bar, preferably adjacent the icon generator button, will, depending on the web site that the user is visiting, display one of two visual modes, to let the user know whether the web site the user is at is a system partner or not. This visual cue area may be shaped like a “button” on the system tool bar but the visual cue area is never clicked by the user—it simply appears in one of two visual modes.

The term “visited web site” will sometimes be used to indicate a web site 162 that the user is visiting and that the user desires to import as a favorite web site in the personal portal screen. The user has gotten to the visited web site through any well known means, for example typing a Uniform Resource Locator (“URL”) in the browser window of the computer and using the browser software to have that web site brought up on the computer screen of the user's computer.

The last step of the method of the present invention is thus the displaying of all of the visual images, merchant partner logos and/or advertising banners on a single screen or page of the personal computer's computer screen which together form the personal portal screen of favorite web sites and favorite advertised web sites. In this context, the visual images referred to also include any e-mail icon 52, as discussed below with respect to certain embodiments.

Security Feature

A merchant must be a partner of the system, i.e. a merchant partner, in order to have the privilege of having his merchant logo “imported”, i.e. brought into the personal portal screen as the symbol of a user's favorite web site and as a symbol representing a link to the merchant's web site. This entails having a serial number supplied by the owner of the system. This serial number is placed in the HTML code near the merchant logo that is to be “imported”. When a software application of the present invention encounters the web site of a merchant that is a merchant partner and hence has a serial number registered to the URL of the merchant's web site, the software will allow the importing to occur, i.e. the software brings the symbol into the personal portal screen. Otherwise, the symbol is ignored.

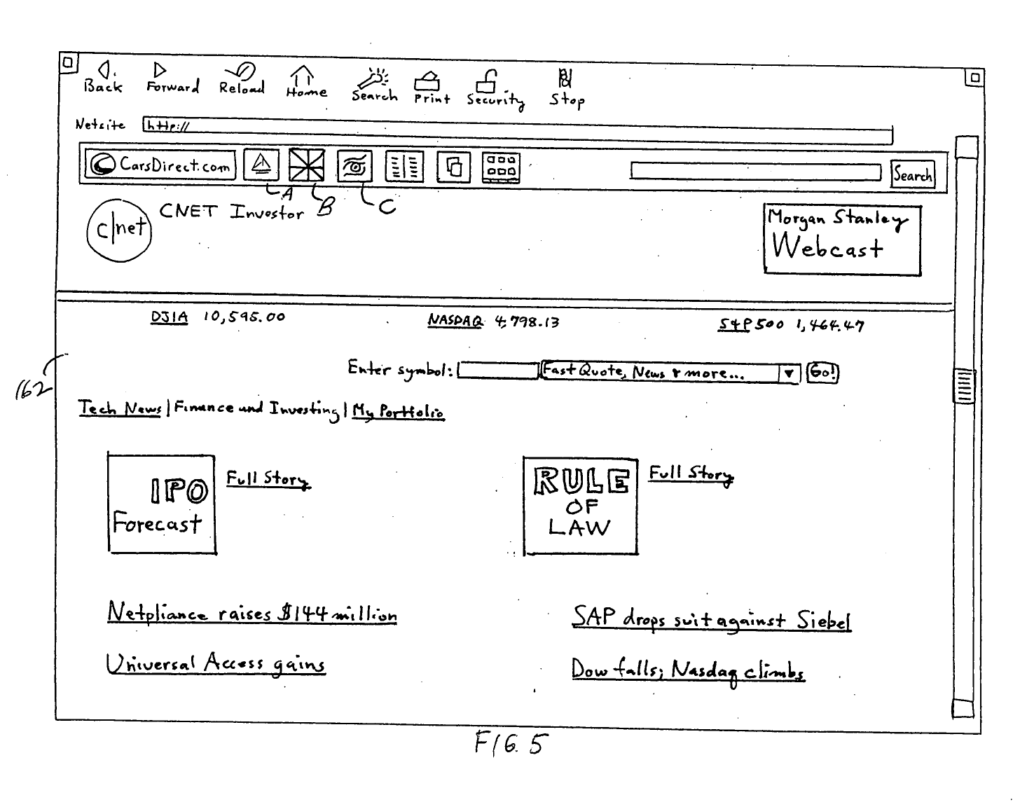

The process of requiring a merchant that wants to be a merchant partner to register with the owner of the system and be supplied a serial number also allows the system to pre-approve the logo of the merchant. This feature is also part of the overall feature of the present invention whereby the merchant logo icons that appear in the personal portal screen are the ones that are placed there by the user. It is important to note that for system partners the user is only able to import a logo that is provided by the merchant. At the same time, the other instance of this feature is where the user, as seen in FIG. 5A, with respect to non-merchant partners, has an opportunity to select an appealing icon from a choice of icons in a dialog-box when bringing that favorite web site into the personal portal screen, as further described below.

Transmitting the addition of the merchant partner logo to the personal portal screen enables the user to then access that logo link as a favorite web site.

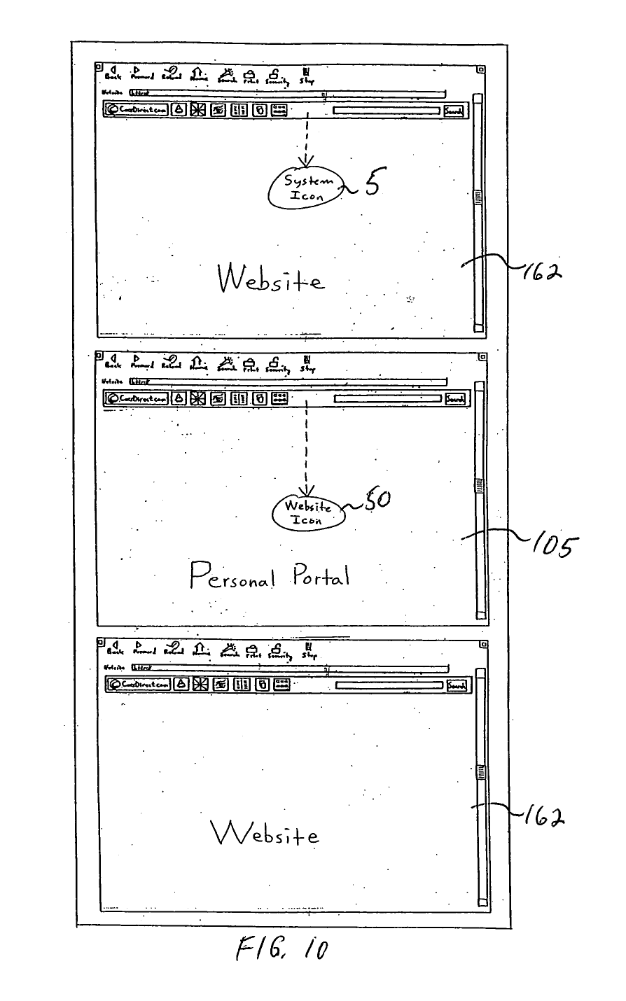

Alternatively, as best seen in FIG. 10, which shows successive views, a user visiting a merchant partner web site containing a merchant partner screen can add a favorite merchant partner web site to the personal portal screen by placing a cursor on a non-button portion of the system toolbar and dragging the cursor into the merchant partner's screen (“merchant partner screen”)—meaning the home page or other screen of the web site of the merchant partner. This dragging will automatically cause the merchant partner screen to disappear and be replaced with the personal portal screen of the user, as seen in the second box illustrated in FIG. 10. Then, whenever the user lets go of the cursor the merchant partner logo appears but only briefly (e.g. a second) followed by the reappearance of the merchant partner screen, as shown in the third box of FIG. 10. In the first two boxes of FIG. 10, the dashed lines indicate the dragging movement, it should be noted that before the dragging causes the merchant partner screen to disappear and be replaced by the personal portal screen, the cursor may in some embodiments appear as a system icon 5, as shown in the first box of FIG. 10.

It should be noted that this method of dragging from a non-button section of the toolbar for the express purpose of importing a merchant's logo into the personal portal screen applies only to system partners. If a user happens to be at a web site that is not a system partner (and the visual cue “button” will indicate that web site's non-partner status), the user will simply click on the icon generator to prompt the three-part window, as described below.

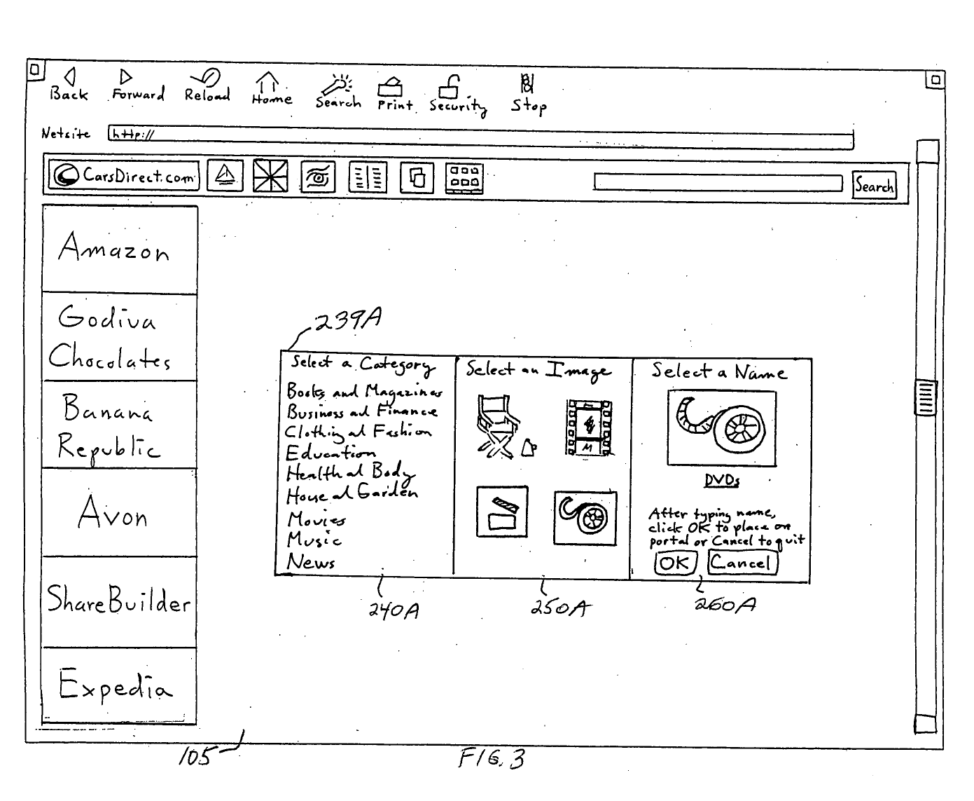

FIG. 3 shows the above-mentioned single three-part window or dialog box, which is typically, although not necessarily, a window smaller than the computer screen and which is automatically presented to the user in the above method. As seen in FIG. 3, the three parts can, for example, be arranged from left to right. In that case, the leftmost part lists a plurality of subject topics, the middle part lists a plurality of images or icons associated with a particular selected topic and the rightmost part is for naming the favorite web site by naming the selected image. The user is prompted to and then does select a topic from the leftmost part of the three-part window. The selection by the user of a particular topic automatically alters the choices of visual images to pick from in the second (middle) part of the three-part selection window from a default selection to those visual images that correspond to the selected topic. The user also is prompted to and does select from the plurality of visual images one of the images that the user wishes will form the icon that appears on the personal portal screen of icons representing the favorite web site. The user selects a visual image from the second part of the selection window by clicking on the desired visual image. Finally, in the rightmost part of the selection window, the user designates any name for the selected image and thereby names the favorite web site.

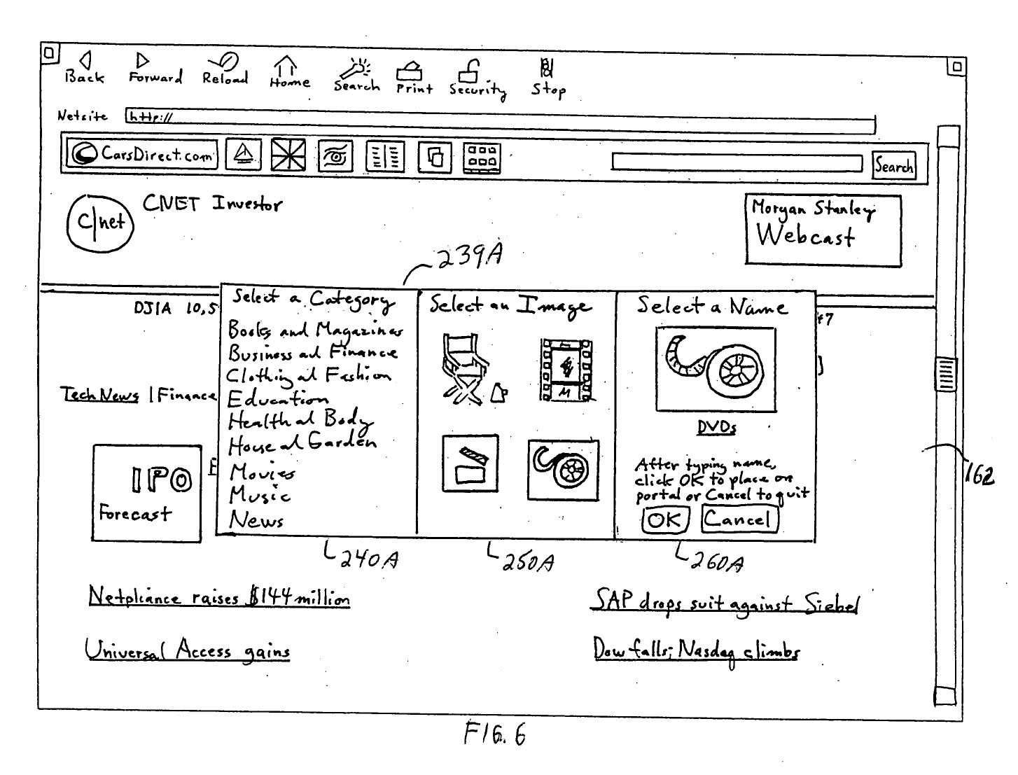

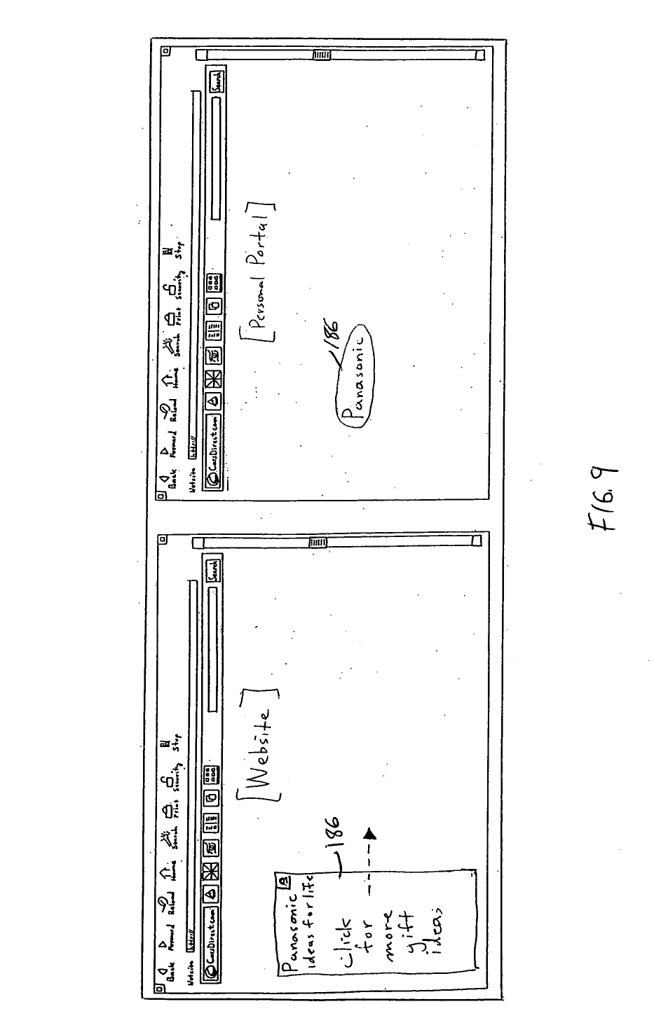

In general, confirmation of a selection may be done by known methods, for example by clicking “OK”. By confirming the selection of the topic category, visual image and name, the system of the present invention automatically and simultaneously transmits the selected visual image and name to the personal portal screen wherein the selected visual image and/or name functions as a link to the favorite web site, as seen in FIG. 6. The user repeats these steps (beginning with entering the Uniform Resource Locator) for each favorite web site until the personal portal screen is as full of links to favorite web sites as is desired, as seen in FIG. 9.

Though somewhat less preferable, it is contemplated by the present invention that a system and method could set up a personal portal screen with visual images alone, without a name. In that case, the step of naming the favorite web site would be omitted and the name would not be transmitted with the visual image to the personal portal screen.

Logo Links Associated with Advertisers

The system and method of the present invention offers the feature of allowing logo icon links associated with advertisers to be brought in to the personal portal screen as icons linked to a favorite advertised web site simply by clicking on the banner. Advertisements by favorite advertised web sites appear in a form allowing them to be chosen as icons in the personal portal screen of a user in accordance with the method and system of the present invention. Typically, the advertising banners would be located on a “different web site”. The term “different web site” as used in this patent application is defined to mean any web site other than the web site of the company doing the advertising, i.e. the owner of the advertising banner.

Under the method and system of the present invention, the advertisements that are imported into the personal portal screen originate in one of two places. The first is simply as an advertisement on any web site (typically not the web site of the company that is doing the advertisement). In other words, the user's favorite advertised web site is not the visited web site An example of this seen in FIG. 9, which shows a “before” and “after” view of the process of dragging a merchant logo out of an advertising banner on a visited web site to the personal portal screen. The advertising banner has a visual symbol in the upper right hand corner of the advertising banner indicating to the user of the method and system of the present invention that the advertiser is a merchant partner. The dotted line in FIG. 9 traces the dragging motion done by the user.

The second place, as seen in FIGS. 1-4, and FIGS. 7-8 is where advertisements in the system of the present invention appear in a designated area of the personal portal screen seen by the user. Preferably, although not necessarily, these advertisements appear in a vertical strip on the left and/or in a vertical strip on the right of each computer screen below the “tool bar” specific to the system of the present invention. The personal portal screen of the user may be blank or may be in the process of being filled up or completely filled up with icon links to favorite web sites and/or favorite advertised web sites (also called “favorite advertising web sites”).

The advertisements appearing on a web site, and the advertisements appearing on the strip of designated space of the user's computer screen, consist essentially of advertisement banners. The banner itself consists essentially of the name of the web site of the advertiser with the advertiser's visual image. Accordingly, the advertiser's logo maintained on the system of the present invention would function as the icon when brought by the user into the personal portal screen. The icon can be the identical advertiser's logo as it appeared on the advertising strip but for particular advertisers the icon can also change into a different logo of that advertiser when brought into the personal portal screen. The system maintaining the software would determine for a particular advertiser whether it has a separate logo for the personal portal screen separate from the advertising strip logo.

Link Mail Feature Associated with System Partner Advertising Banners

A visual symbol on a portion of the advertising banner located on a visited web site, typically the corner of the banner, indicates that the advertiser is a merchant partner. When the user mouses over (puts the cursor over) that visual symbol portion of the advertiser's banner or logo on the visited web site, a very small pop-up notice will appear saying “Godiva Chocolatier is a partner of the system”. This link mail will disappear during the time that the banner is being dragged into the personal portal screen. Experienced users will often know merely from the visual symbol alone that the advertiser is a partner of the system and will not need to even mouse over the symbol. With respect to advertising banners appearing in the designated advertising strip there is no need to notify the user that the advertiser is a partner of the system since the fact that the advertiser is in the advertising strip it is already known that the advertiser is a partner of the system.

Note that it is not precise to describe the logo-link as being “dragged” into the personal portal screen because when the user holds down the cursor and moves the cursor toward the personal portal screen the logo-link is not visible and only a “cursor” or a system trademark is visible. Only when the logo-link reaches the personal portal screen and the user lets go of the cursor does the cursor representing the logo-link change into the visual symbol, a trademark that represents the merchant.

The logo-link once brought into the personal portal screen will be accompanied by a “link mail” window that will contain an advertising “teaser” (i.e. “20% off for one week only”). This occurs when the user lets go of the mouse after dragging the advertiser's logo-link to the personal portal screen, at which point the user will see the logo-link accompanied by a link mail window. In general, the link mail is seen for approximately two or three seconds whenever the user holds the cursor on the logo-link. Periodically, the link mail will change in accordance with the advertiser's arrangement with the manufacturer and distributor of the present system. In other words, so long as the user keeps the logo-link on the personal portal screen, the user will discover, once he or she “mouses over” the cursor on the logo, a new link mail that will appear for approximately two or three seconds.

It should be noted that the link mail window is not the same as an “alt text” window. In fact, the link mail window can be used in concert with an alt text window. The alt text window is only a name of an object and is used when the operating software cannot download visual images—it is an alternate text for the missing objects that are not downloadable on text-based operating software. In contrast, the link mail window is a periodically changing commercial embellishment of the object associated with the link mail window. It adds new information and that information periodically changes. In addition, the link mail needs an image—or an alt text—to give it meaning. For example, “20% off for one week only” is ambiguous without reference to the visual image which the teaser refers to.

Another feature of the link mail messages is that the user is automatically notified when a new link mail message is there because a little symbol will appear in the upper right hand corner of the merchant logo-links that have been already placed in the personal portal screen. This encourages users to mouse over the icon to read the link mail. Once the user reads the new link mail message the little visual symbol disappears until a further link mail message arrives.

The periodically changing link mail accompanying advertiser's logo-link serves as a kind of electronic mail transmission, which is why it is called “link mail” or “electronic link mail”. Link mail has significant advantages over traditional e-mail for advertisers. The main advantage is that is not presented in the manner that electronic junk mail, known as spam, is presented.

Accordingly, by simply clicking once on an advertising banner, holding down the mouse and dragging the logo into the personal portal screen, users would be able to bring and keep the advertiser's brand logo as an icon-link in the user's personal portal screen. This is a strong inducement for advertisers to supplement their appearance in the designated advertising strip or sidebar by placing the system partner's visual cues in the banners that merchants place throughout the World Wide Web. But it is also a strong inducement for advertisers to be system partners (merchant partners) of the system. The link mail feature provides an incentive for advertisers to associate themselves with the system because they will want to take further advantage of the portal screen-based brand logo link by letting users know of special sales and offers or discounts and the like.

Consequently, advertisers can be induced to participate in the system, since users will then be more likely to keep the advertiser's brand logo as an icon-link in the personal portal screen. The link mail will provide another incentive for advertisers to participate in the system.

The advertiser would have to maintain the computer code to allow the dragging out of the banner into the user's personal portal screen, as described.

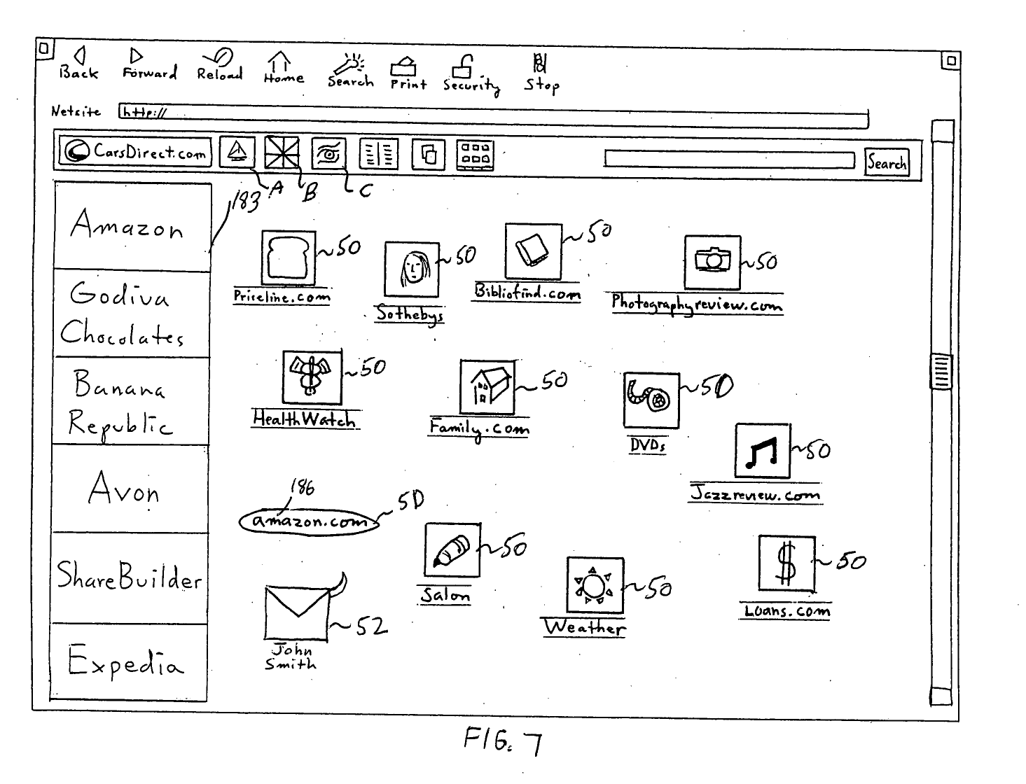

It should be noted that the advertising banner for the favorite advertising web site must necessarily already contain a name of the company doing the advertising. Accordingly, no name need be selected by the user since the user is simply “creating” by the click-and-drag method the advertising brand logo as an icon-link for the personal portal screen. As with the favorite web site, the advertising visual image functions as a link to the favorite advertised web site. For example, as seen in FIG. 7, the advertising banner “amazon.com” appears as a favorite advertising visual image or icon in the personal portal screen since the user has already brought that web site into the user's personal portal screen. Nonetheless, the advertising banner continues to be shown in the advertising strip 183 of the computer screen.

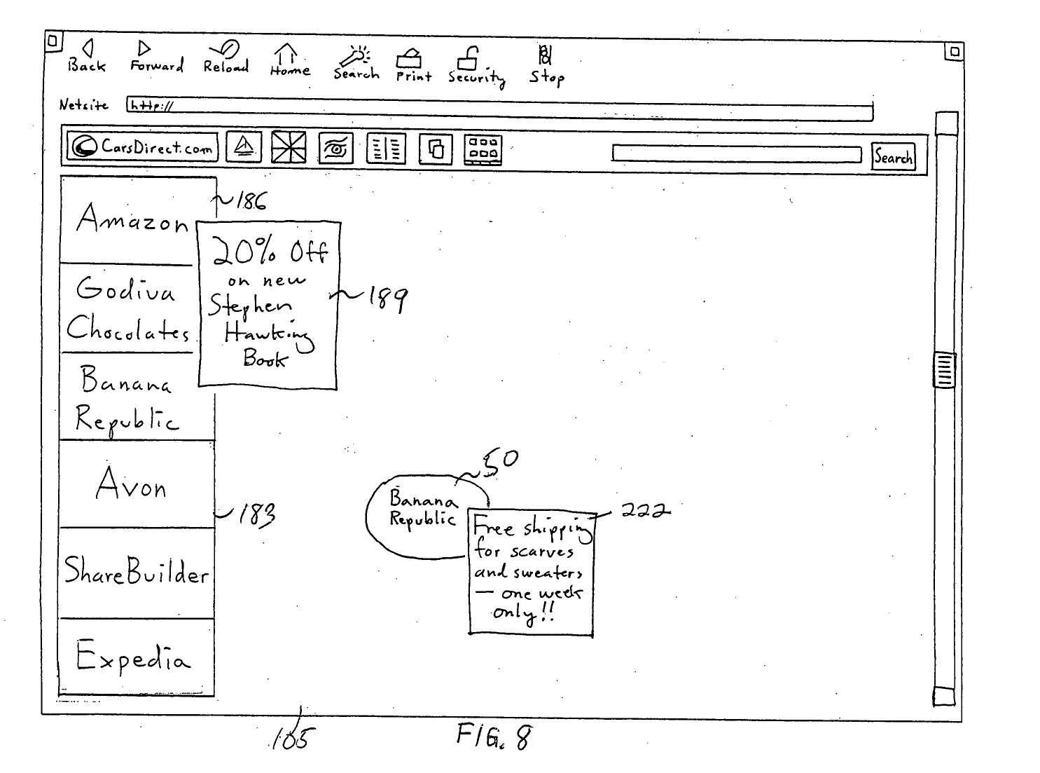

The link mail function is illustrated in FIG. 8.

As partly explained above, a unique arrangement with advertisers who advertise on a strip of space on the personal portal screen as well as on other web pages throughout the World Wide Web allows additional icons to be generated for favorite web sites. This method involves two complementary yet separate functions. From the advertising strip of the personal portal screen a user will click once on an advertiser's banner, hold down the cursor, and then proceed to “drag” or pull out from the banner in to the personal or general area of the personal portal screen the advertiser's brand logo icon-link. When the user lets go of the mouse, the user will see the advertiser's logo-link (not the ad banner) in the personal portal area accompanied by the link mail window that will contain a message from the advertiser, which will periodically change so long as the logo is kept on the personal portal screen. (The user will be able to read these new link mail messages when the user periodically “mouses over” the icon, which will prompt the link mail window).

It should be noted that the link mail feature only works once a system partner logo has been imported into the personal portal screen. With respect to advertising banners that do not appear on the advertising strip of the personal portal screen but rather appear at any web page that contains advertisements, the ad banners will look and function just like any conventional ad banner except for the appearance of a tiny image associated with the personal portal screen, which could be placed in the upper-right hand corner of the ad banner. That pop-up notice feature is not a link mail.

Consequently, with this feature, the user has an alternative way to access an advertiser's logo-link using a complementary method that applies when the user is at a web page on the World Wide Web. Through an additional arrangement, a portion, typically although not necessarily a tiny portion, of banner advertisements will contain an image associated with the personal portal system. The presence of this additional image to the banner ad means that a user clicks once on the ad banner to prompt that merchant's logo. The logo can then be “dragged” anywhere for an inch or less. This movement will prompt the personal portal screen to appear. But then when the user lets go of the mouse, the user sees that the merchant's logo is on the personal portal screen for a second and then the screen automatically reverts back to the page the user was on. The function will appeal both to the merchant associated with the ad banner and the merchant site on which the ad banner appears because it allows the user to interact with the merchant banner without leaving the site of the merchant within which the ad banner appears.

It should be noted that the data in the link mail “message” can assume a wide variety of forms and need not be limited to text. The link mail can be a graphic image or a video image. In general, the link mail message can support HTML, XML and any other web authoring language.

This method and system for a personal portal Internet screen can be advertised within other advertising banners throughout the World Wide Web. When the user “mouses over” the image of the personal portal system in the ad banner that will be placed in the upper right hand corner of a merchant's ad banner 186, a message 181 will prompt such as “Godiva Chocolatier is an X partner (where “X” is the owner of the personal portal system). Click here to read more, “here” being the tiny personal portal image in the upper right-hand corner of the banner. The user can then click through on this section of the ad banner only in order to be taken to the system's dotcom information and download page to read more about the personal portal screen system. In addition, and continuing with the Godiva Chocolatier example, should the user decide to download the system after clicking through on the ad for the system (that, again, appears in the upper right hand corner of a Godiva ad banner), a Godiva Chocolatier logo link will appear on the personal portal screen after the download is complete in appreciation for the fact that the user learned of the personal portal system through Godiva Chocolatier. This method will appeal to merchants because they will realize that a persuasive ad-within-the-merchant ad for the personal portal screen will result in a logo link for the merchant.

In the case of favorite advertising web sites, the user repeats the step of clicking on and dragging an advertising visual image for each favorite advertised web site until the personal portal screen is as full of links to favorite advertised web sites as is desired. This may be done before, after or in the middle of all or part of the process of adding icons for favorite web sites (non-advertising icons) to the personal portal screen.

Link mails also have a link mail forwarding feature. At the bottom of the expanded link mail window are three little windows—one for identifying the sender, one for identifying a recipient and one for identifying a message. By filling in these little windows the user can electronically forward the expanded link mail to any recipient able to receive E-Mail, for example. a friend, with a message saying “check out this interesting offer”. Upon clicking the end option appearing preferably at the bottom of the link mail box/window, the link mail window reverts to its original size.

Mobility Feature

Since the personal portal screen of mobile or movable icons represents links to favorite web sites, for each icon on the screen, the system attaches a graphical image, the mobile icon, to . a URL address and place it in an Internet browser environment. The result of the method of the present invention is a collection of movable icons linked to respective URL addresses, where each of the movable icons is accessible while connected to the Internet and wherein the entire collection fills a personal portal screen within an Internet browser environment.

A novel feature of the method and system of the present invention is the mobility of the elements of the personal portal screen created by the method and system of the present invention. It should be noted that whenever an icon-link is placed on the personal portal screen, that icon-link is mobile. By simply single clicking on the icon within the personal portal screen, any particular icon-link can be dragged to and relocated to another location on the screen. Keeping in mind that the environment in which this is occurring is an online environment—an Internet environment—this is a significantly novel feature. Having created a personal portal screen of icon-links to favorite web sites and favorite advertising web sites, the user can enjoy relocating them at will as the user would icons on a desktop computer—but here the icons are in an Internet environment. Each icon is a link to a web site and represents the opening (portal) screen that the user maintains for “going online”. In contrast, for example, when one goes to the first site, the first portal screen of a typical online service provider, the elements on the screen are not at all mobile—they are instead static. In fact, a basic premise of the entire Internet environment is that it is a static or nonmovable environment. The fact that single-clicking is not presently used to move around icons or elements of a web site while online, is probably why single-clicking, and not double-clicking, is available to be used to navigate to various web sites.

It is also contemplated by the present invention that the personal portal screen can have an icon representing an e-mail (electronic mail) inbox corresponding only to electronic messages sent from a particular person who also uses the system. Further, the e-mail icon would have a visual cue thereon notifying the owner of the personal portal screen that a new message from that individual has been sent. This e-mail capability is for users of the system as well as for e-mail transmitted through traditional well known media such as Hotmail®, Yahoo® or AOL®. Thus, the e-mail icon capability creates a private community between whom e-mail transmission occurs because the e-mail message will not go to a traditional inbox containing messages from all sources; instead the e-mail messages will go to the corresponding links, each of which functions as an inbox by itself. A private mail route between the user and his or her favorite e-mail senders has been created. See FIG. 7 in which the personal portal screen contains an e-mail “icon” 52 relating to e-mail from “John Smith” with respect to which a visual cue indicates new unopened mail.

The System

As described above, a computer system 100 of the present invention is coupled to the World Wide Web or another non-centralized global network of communication links and has an operating system that enables a web browser to locate and access a web site, typically by a Uniform Resource Locator. The system operating on computer 100 aesthetically creates and allows access in an aesthetically appealing way to a personal portal screen 105 of icons having links to as many favorite web sites as is desired.

The system operating on personal computer 101 includes display structure 250 which allows computer 101 to display a personal portal screen 105 to a user. Display structure 250 allows for the icons within the personal portal screen to be movable by the user throughout the screen using the normal techniques for dragging images across a computer screen, such as would typically be used in an off-line desktop environment. Display structure 250 includes access structure 110 that allows a user at a web site of the system computer to access a blank personal portal screen 115. Display structure 250 also includes the system tool bar 255, which, upon downloading the system software, displays buttons to the user that represent functions performed by other structural components of the system of the present invention.

To initiate the process of importing a favorite web site or advertising web site into the personal portal screen, the user clicks on the generic icon generator button C on the system tool bar display structure 255, which button activates icon generator function performed by icon generator structure 120. A second button B on the system tool bar display structure 255 provides a visual cue as to whether the web site the user is visiting is a system partner (merchant partner) or not. Accordingly, the icon generator function is not turned “on” or “off”. The user simply clicks on it to prompt the three-part generic icon window or the system partner icon depending on what the visual cue B indicates. Using the URL window of the browser software the user enter's the Uniform Resource Locator 135 of a favorite web site while icon generator structure 120 is functioning. Optionally, search structure 131 allows a user to locate and then visit a favorite web site 162 by activating a search engine after clicking on a drop down arrow 133 that activates a search mode. Search structure 131 thereby functions as a shortcut that avoids the user's having to first go to a search engine's web site and then conduct the search.

The present invention envisions a system coupled to a global telecommunications network 119 for creating and maintaining a personal portal screen of icons 50 linked to favorite web sites and icons 50 linked to favorite advertising web sites wherein advertisers place advertising banners. In the most comprehensive embodiment of the system of the present invention. Note that the user cannot necessarily tell whether the icon in the personal portal screen emanated from and is linked to a favorite web site or a favorite advertising web site, although in alternative embodiments it is contemplated that the user could be able to discern that visually from a distinction in appearance of the icons.

The system of the present invention includes the following elements;

(a) an aesthetically appealing personal portal screen 105 of icons wherein said icons function as links to as many favorite web sites and/or favorite advertising web sites as is desired, the icons being movable across the personal portal screen while a user is connected to the global communications network;

(b) a personal computer 101 having an operating system that enables a web browser to locate and access a web site, such as by a Uniform Resource Locator;

(c) a systems computer 122 that maintains a system web site accessible by the personal computer, and

(d) system software 111 maintained by the system web site and loadable by a user of the system at a personal computer, said system software including

(i) display structure 250 for displaying a personal portal screen to a user, said personal portal screen being blank initially, in certain embodiments display structure including system tool bar display structure;

(ii) icon generator structure 120 for generating icons that function as links to favorite web sites. The icon generating structure includes an icon generating button and including a visual cue button that signals to a user whether a visited web site is a merchant partner visual cue structure to let the user know whether the web site the user is visiting is a system partner or not;

(iii) dialog box structure 239A (or three-part dialog box structure 239) for creating icons associated with visited web sites of non-merchant partners by presenting a three-part dialog box 239 for selecting a topic, a visual image and a name of the non-merchant partner's visited web site. The dialog box structure is used when importing into the personal portal screen a non-merchant partner's visited web site,

(iv) confirmation structure 170 for confirming the selection of a topic, a visual image and a name associated with a favorite web site after being prompted to do so and transmitting the selected visual image and name to the personal portal screen wherein the selected visual image functions as a link to the favorite web site.

To the extent that the personal portal screen is to include favorite advertising web sites rather than just favorite web sites, the system would also include (v) transmission structure for transmitting an advertiser's logo of a favorite advertised web site to the personal portal screen when a user clicks on the advertising banner wherein the advertising banner functions as a link to the favorite advertised web site.

Alternatively, the system may also be thought of as omitting elements (a) and (b) listed above and including only the remaining above-listed elements.

The system in a preferred embodiment also includes visual cue structure 175 associated with the second button B on the system toolbar and advertising strip structure 189 associated with advertising strip 183 of personal portal screen 105 as well as other elements described below.

In the present invention, the system allows a single three-part window to cover selection of the topic, image and name rather than three separate windows. Accordingly, dialog box structure 239 generates a three part dialog box 239A that has three parts, a topic selection part or first window 240A associated with topic selection structure 240, a visual image part or second window 250A associated with visual selection structure 250 and a naming part or third window 260 associated with naming structure 260. Although the display of a three-part window differs from the display of three separate windows that are seen only one after the other, the structure itself is the same.

In the case of an advertising visual image that is contained in advertising banner 186, transmission structure 180 transmits the advertising banner 186 for a favorite advertised web site 185 to the personal portal screen when a user clicks on the advertising banner 186 and the advertising banner 186 functions as a link to the favorite advertised web site 185.

Advertising strip structure 189 allows advertising banners 186 to appear in a vertical strip 183 of space on the left and/or in a vertical strip of space on the right of each computer screen below the “tool bar” specific to the system of the present invention.

Link mail structure 220 associates a link mail 222 with a portion of a merchant logo when the merchant logo is located in the personal portal screen. Link mail transmission structure 220A forming part of link mail structure 220 allows a periodic transmission of “tease mail” from an advertiser to the link mail 222. The tease mail is electronic mail that periodically updates the contents of the link mail 222. Although the contents of the tease mail is provided by the advertiser, the tease mail update itself is sent over the Internet from the web site maintained by a computer of the provider of the system of the present invention to the personal computer of the user of the system whose personal portal screen has a link mail 222. Link mail forwarding structure 221A allows the forwarding of link mail to another party when the user right clicks on the link mail and is given an enlarged link mail with three little windows and an option to “send”.

As a result of link mail structure 220, the present invention also contemplates a computer system for a personal computer coupled to a global telecommunications network, which personal computer has an operating system enabling a web browser system is provided for creating and maintaining a personal portal screen of favorite web sites and favorite advertising web sites that allows periodic updating of advertising information. The computer includes an aesthetically appealing personal portal screen of icons to be created that function as links to as many favorite web sites and/or favorite advertising web sites as is desired, said icons being movable across the personal portal screen while a user is connected to the global communications network. The computer system uses a personal computer having an operating system that enables a web browser to locate and access a web site such as by a Uniform Resource Locator. The computer system interacts with web sites on the global telecommunications network wherein advertisers place advertising banners. The computer system includes a systems computer that maintains a system web site accessible by the personal computer, said systems computer receiving mail from advertisers. The computer system includes system software maintained by the system web site and loadable by a user of the system at a personal computer. The system software includes the following elements:

(i) display structure 250 for displaying a personal portal screen to a user that includes between zero and a plurality of icon links of favorite web sites and favorite advertising web sites;

(ii) visual cue structure 200 for notifying the user whether or not the web site the user is visiting is owned/operated by a merchant, i.e. “system” partner or is owned/operated by a non-merchant,

(iii) icon generator structure 120 that when activated for a visited web site of a merchant partners generates a window on the computer screen showing the merchant's logo to be imported as an icon link into the personal portal screen and prompting the user to click or otherwise activate the importing on that logo into the personal portal screen and when activated for a visited web site of a non-merchant partners generates a three-part dialog box for generating an icon link in the personal portal screen for that non-merchant partner;

(iv) advertising strip structure 189 for allowing advertising banners to appear as advertisements in a designated strip of space on the personal portal screen;

(v) three-part dialog box structure 239A including topic selection substructure for opening up a first selection window of topics and selecting a topic from the first selection window, visual image selection substructure for opening up a second selection window of visual images and selecting a visual image from the second selection window, and naming substructure for naming the favorite web site after being prompted to do so, said three-part dialog box providing an aesthetically appealing way of creating icons;

(vi) confirmation structure for confirming the selection of the topic, visual image and name after being prompted to do so and transmitting the selected visual image and name to the personal portal screen wherein the selected visual image functions as a link to the favorite web site,

(vii) transmission structure for transmitting a merchant logo for a favorite advertised web site to the personal portal screen in situations where the favorite advertised web site is not the visited web site. Transmission structure is activated when the user clicks on the advertising banner to “drag” out the advertiser's logo into the personal portal screen where the logo functions as a link to the favorite advertised web site. Transmission structure also includes advertiser logo transfer structure for transferring advertisers'logos specifically from the advertising strip structure to a portion of the personal portal screen containing the icons that functions as links; and

(viii) link mail structure for displaying marketing information in the form of a link mail connected to the selected visual image of a system partner. The link mail structure includes link mail transmission structure that allows a periodic transmission of electronic mail from an advertiser to the link mail structure over the Internet from the system web site to the personal computer. The electronic mail is seen by the user as link mail connected to the visual image of the system partner. Link mail structure includes notification structure that automatically notifies a user that the link mail structure received a link mail by displaying a small visual symbol in or on the selected logo-link for the merchant partner while that logo-link appears in the personal portal screen.

The personal computer also uses well known components, namely a Central Processing Unit (CPU), and that CPU has access to various kinds of well known storage structure. The CPU also uses any of a variety of well known operating systems, including but not limited to Microsoft Windows 95, 98, 2000 and XP operating systems, to function and to interact with the network that it is coupled to.

It should be noted that the system and method of the present invention also allow the personal portal screen of the user to consist only of merchant logos (and the sidebar advertising strip).

As previously noted with respect to the method, a somewhat less preferable system in accordance with the present invention could set up a personal portal screen with visual images alone, without a name. In that case, the naming structure 260 would be omitted and confirmation structure 170 would transmit only the selected visual image and not the name to the personal portal screen 105 to be an icon 50.

Technical Aspects

Below is a discussion of the technical aspects for achieving the results of the present invention.

The series of “prompting windows” (e.g. 240A, 250A, 260A and the URL prompt window) that appear subsequent to the clicking of the icon generator require the user to make choices that enter values for different criteria. Using well-known software methods, these values will determine where the icon will be placed (although the user will be able to select and drag a previously placed icon to any other available space on the personal portal screen 105 using well-known techniques), what URL will be linked to the icon, the graphics for the icon, and the category it will appear under.

With the icon generator structure 120 active, the user enters the Uniform Resource Locator of the user's favorite web site. To achieve this, a URL prompt window will be implemented as an HTML editable text field. The user will input/enter the URL of the desired web site into this field, and then hit the “enter” or “return” key in order to visit the desired site. This triggers another ASP script associated with the icon table used to store the icon information. This table may be utilized, for example, in the most recent version of SQL server. The icon table will store the icon image in the well known file format used for Internet images called “gif”, will store the URL associated with it, as well as the name of the icon on the personal portal screen, and the topic category to which the icon belongs. After the URL is submitted, the user is taken to the first selection window to select a category. The topic or category names will be in an HTML table, for formatting purposes, and each will have an associated ASP code that will store the respective values of each category for input into the aforementioned “icon table”. This procedure is the same for naming web sites that the user is already visiting as a result of a search except that in that case the URL is not typed in.

Upon selection of the category, the user is taken to the second selection window 155 to select a visual image. Once again, the visual images are organized on the screen in an HTML table. They will be uniform size “gif” images (100 px×100 px). Each of these images will have an associated ASP code and this code will store the respective variable value for the visual image to display on the personal portal screen.

The selection of the name of the favorite web site is accomplished when the user is prompted by a screen that allows the user to give a name under the visual image. After typing in the name in an HTML text field, the user clicks on the ‘OK’ button, and that event drives a script that will store the name variable and then perform the update for the icon table with all the preceding variables. Otherwise, the user may click on the cancel button to take the user out of the process and back to the home page of the system.

The code needed to implement the method and system of the present invention as it relates to advertising icons is as follows. The system will utilize an event driven script, i.e. a piece of code that will execute based on the action performed by the user. The term “icon” or “advertising icon” as used herein structure the advertiser's logo associated with the advertising banner 186 after it has been transmitted to the personal portal screen 105. The generation of the advertising icon will use code similar to the code used to generate icons. The main difference is that with advertising icons no user input will be required because the variables that need to be passed will be passed automatically. By variables is meant the subject category, visual image and name that the user normally selects when generating regular icons. When the user clicks an advertising banner 186 it triggers an event that passes all these variables to the code used to generate the icon.

The user of the system of the present invention also has other features offered by the system such as the ability to access the user's E-mail once the user logs into the system by entering name and password as explained above. More importantly, the user will be able to create a personal portal screen to send to other prospective users.

It should be noted that the term “Internet” used herein is a specific kind of a non-centralized global network of telecommunication links. The present invention can also be applied to other non-centralized global network of communication links. Accordingly, the term “network” should be understood to refer to any non-centralized global network of communication links.

Although the invention has been described in detail in the foregoing specification and accompanying drawings with respect to various embodiments thereof, these are intended to be illustrative only and not limiting. One skilled in the art will recognize that various modifications and variations may be made therein which are within the spirit and principles of the invention and the scope of the appended claims. It is not desired to limit the invention to the exact description and operation shown and described. The spirit and scope of this invention are limited only by the spirit and scope of the following claims.

What is claimed is:

1. A method for a user to set up an aesthetically appealing personal portal screen of bookmarked web sites that are iconic, movable and accessible, for a personal computer forming part of a computer system coupled to a network, the personal computer having an operating system that enables a web browser to locate and access a web site, comprising:
loading a system software while at a web site maintained by the computer system in order to access a blank personal portal screen, said system software including a system toolbar that is maintained on a computer screen during navigation throughout the World Wide Web,
for each visited web site that the user desires to import into the personal portal screen as a favorite web site,
when a visual cue on a system tool bar indicates the visited web site is a merchant partner, clicking on an icon generator function on the system toolbar, said clicking opening a window displaying a merchant partner logo and prompting the user to confirm the addition of the visited web site of the merchant partner to the personal portal screen thereby automatically transmitting the merchant partner logo to the personal portal screen so that the merchant partner logo can function as a link to the favorite merchant partner web site,
when the visual cue on the system tool bar indicates the visited web site is not a merchant partner, clicking on the icon generator function on the system tool bar, said clicking automatically opening up the three-part selection window for the selection of a topic and a visual image and for designating a name, selecting a topic in one part of the selection window, a visual image in a second part of the selection window and designating a name in a third part of the selection window, and simultaneously confirming the selection of the topic and visual image and the designation of the name after being prompted to do so and in so doing transmitting the selected topic and visual image and name to the personal portal screen, wherein the selected visual image and/or designated name appearing on the personal portal screen on the personal computer functions as a link to the favorite web site and
displaying all of the visual images and/or merchant partner logos on a single page to form the personal portal screen of favorite web sites and favorite advertised web sites.

2. The method of claim 1, wherein said loading is a downloading from a web site maintained by a system provider.

3. The method of claim 1, wherein a visited web site that is a merchant partner can also be imported into the personal portal screen by placing a cursor on a non-button portion of the system toolbar and dragging the cursor into a merchant partner screen, said dragging causing the merchant partner screen to disappear and be replaced with the personal portal screen, wherein upon letting go of the cursor a merchant partner logo appears briefly in the personal portal screen followed by a reappearance of the merchant partner screen

4. The method of claim 3, wherein a non-merchant partner can also be imported into the personal portal screen by placing a cursor on a non-button portion of the system toolbar and dragging the cursor into a non-merchant partner screen, said dragging causing the merchant partner screen to disappear and be replaced with the personal portal screen, wherein upon letting go of the cursor a default logo appears briefly in the personal portal screen followed by a reappearance of the non-merchant partner screen

5. A method for a user to set up an aesthetically appealing personal portal screen of bookmarked web sites that are iconic, movable and accessible, for a personal computer forming part of a computer system coupled to a network, the personal computer having an operating system that enables a web browser to locate and access a web site, comprising:
loading a system software while at a web site maintained by the computer system in order to access a blank personal portal screen, said system software including a system toolbar that is maintained on a computer screen during navigation throughout the World Wide Web,
for each visited web site that the user desires to import into the personal portal screen as a favorite web site,
when a visual cue on a system tool bar indicates the visited web site is a merchant partner, clicking on an icon generator function on the system toolbar, said clicking opening a window displaying a merchant partner logo and prompting the user to confirm the addition of the visited web site of the merchant partner to the personal portal screen thereby automatically transmitting the merchant partner logo to the personal portal screen so that the merchant partner logo can function as a link to the favorite merchant partner web site,
when the visual cue on the system tool bar indicates the visited web site is not a merchant partner, clicking on the icon generator function on the system tool bar, said clicking automatically opening up the three-part selection window for the selection of a topic and a visual image and for designating a name, selecting a topic in one part of the selection window, a visual image in a second part of the selection window and designating a name in a third part of the selection window, and simultaneously confirming the selection of the topic and visual image and the designation of the name after being prompted to do so and in so doing transmitting the selected topic and visual image and name to the personal portal screen, wherein the selected visual image and/or designated name appearing on the personal portal screen on the personal computer functions as a link to the favorite web site and
for each web site that the user desires to import into the personal portal screen as a favorite advertising web site,
clicking on an advertising banner for a favorite advertised web site while the advertising banner is located in an advertising strip of the personal portal screen and transmitting an advertiser's logo from the advertising banner to a general area of the personal portal screen wherein the advertiser's logo functions as a link to the favorite advertised web site.
clicking on an advertising banner for a favorite advertised web site while the advertising banner is located on a different web site and transmitting an advertiser's logo from the advertising banner to the personal portal screen wherein the advertiser's logo functions as a link to the favorite advertised web site,
displaying all of the visual images, merchant partner logos and/or advertising banners on a single page to form the personal portal screen of favorite web sites and favorite advertised web sites.

6. The method of claim 5, wherein transmitting means dragging.

7. The method of claim 5, wherein a visited web site that is a merchant partner can also be imported into the personal portal screen by placing a cursor on a non-button portion of the system toolbar and dragging the cursor into a merchant partner screen, said dragging causing the merchant partner screen to disappear and be replaced with the personal portal screen, wherein upon letting go of the cursor a merchant partner logo appears briefly in the personal portal screen followed by a reappearance of the merchant partner screen.

8. The method of claim 7, wherein a non-merchant partner can also be imported into the personal portal screen by placing a cursor on a non-button portion of the system toolbar and dragging the cursor into a non-merchant partner screen, said dragging causing the merchant partner screen to disappear and be replaced with the personal portal screen, wherein upon letting go of the cursor a default logo appears briefly in the personal portal screen followed by a reappearance of the non-merchant partner screen.

9. The method of claim 5, wherein an advertising banner positioned on a different web site briefly displays a message that the owner of the banner is a partner of the computer system when the user places a cursor over the banner.

10. The method of claim 5, wherein an advertising banner positioned on a different web site briefly displays a message that the owner of the advertising banner is a partner of the computer system when the user places a cursor over the banner and wherein an advertising banner positioned in the advertising strip briefly displays a message that the owner of the advertising banner is a partner of the computer system when the user places a cursor over the banner.

11. The method of claim 5, wherein an advertiser's logo that has been dragged into the general area of the personal portal screen of the computer system from the advertising strip of the personal portal screen contains a link mail that briefly displays marketing information from the owner of the advertising banner when a user places a cursor over the advertising banner.

12. The method of claim 11, wherein the link mail message can be displayed in an expanded format and wherein the link mail message can be forwarded to a recipient of electronic mail.

13. The method of claim 5, wherein an advertiser's logo that has been dragged into the general area of the personal portal screen of the computer system from the advertising strip of the personal portal screen contains a link mail that briefly displays marketing information from the owner of the advertising banner when a user places a cursor over the advertiser's logo and wherein an advertiser's logo that has been dragged into the personal portal screen from a different web site contains a link mail that briefly displays marketing information from the owner of the advertiser's logo when a user places a cursor over the advertiser's logo.

14. The method of claim 13, wherein the link mail can be displayed in an expanded format and wherein the link mail message can be forwarded to a recipient of electronic mail.

15. A computer system using a personal computer coupled to a global communications network, said personal computer having an operating system enabling a web browser to locate and access a web site, wherein the computer system allows the personal computer to aesthetically create and allow access in an aesthetically appealing way to a personal portal screen of icons having links to as many favorite web sites as is desired, comprising:
a system computer that maintains a system web site accessible by the personal computer, said
system computer receiving mail from advertisers,
computer software including
a. display structure for displaying to a user a personal portal screen of visual images that are movable across a computer screen, said display structure including access structure for a user at a web site of the system computer to access a blank personal portal screen by downloading a system software that includes a system toolbar;
b. icon generator structure for generating icons that function as links to favorite web sites, said icon generating structure including an icon generating button and including a visual cue button that signals to a user whether a visited web site is a merchant partner;
c. visual cue structure that displays a visual cue on the system toolbar to indicate whether a visited web site is a merchant partner or a non-merchant partner;
d. dialog box structure for creating icons associated with visited web sites owned by non-merchant partners, said dialog box structure including topic selection substructure for opening up a first selection window of topics and selecting a topic from the first selection window, visual image selection substructure for opening up a second selection window of visual images and selecting a visual image from the second selection window, and naming substructure for naming the favorite web site after being prompted to do so;
e. confirmation structure for confirming the selection of the topic, visual image and name, after being prompted to do so and transmitting the selected visual image and name to the system computer, forming a basis for the personal portal screen displayed on the personal computer, wherein the selected visual image functions as a link to the favorite web site.

16. The system of claim 15, wherein connected to the selected visual image is a link mail structure that can receive marketing information in a form of a link mail sent from the favorite web site of a merchant partner and can display said link mail when a cursor is placed over the selected visual image.

17. The system of claim 16, wherein the link mail structure has notification structure to notify a user that said link mail structure received a link mail, said notification structure displaying a small visual symbol and wherein the link mail structure can receive updated marketing information periodically.

18. The system of claim 17, wherein the link mail structure can display the marketing information in a link mail in an expanded format and can forward the link marketing information to another address on the Internet

19. The system of claim 15, wherein the dialog box structure is a three-part dialog box structure.

20. The system of claim 15, wherein said system also includes transmission structure for transmitting an advertiser's logo for a favorite advertised web site to the personal portal screen when a user clicks on and drags the advertising banner located on a visited web site to the personal portal screen wherein the advertising banner functions as a link to the favorite advertised web site.

21. The system of claim 20, wherein the transmission structure includes advertising strip structure for allowing banners to appear as advertisements in a designated strip of space on the personal portal screen and includes advertiser logo transfer structure for transferring an advertiser's logo located in the designated strip to a portion of the personal portal screen containing the icons that function as links to favorite web sites and favorite advertising web sites.

22. The system of claim 20, wherein connected to the selected visual image is a link mail structure that can receive marketing information in a form of a link mail sent from the favorite web site of a merchant partner and can display said link mail when a cursor is placed over the selected visual image.

23. The system of claim 22, wherein the link mail structure has notification structure to notify a user that said link mail structure received a link mail, said notification structure displaying a small visual symbol, and wherein the link mail structure can receive updated marketing information periodically.

24. The system of claim 22, wherein the link mail structure can display the marketing information in a link mail in an expanded format and can forward the link marketing information to another address on the Internet.

25. The system of claim 20, wherein the dialog box structure is a three-part dialog box structure.

26. The system of claim 15, wherein said system also includes
(a) an aesthetically appealing personal portal screen of icons wherein said icons function as links to as many favorite web sites as is desired, said icons being movable across the personal portal screen while a user is connected to the global communications network and
(b) a personal computer having an operating system that enables a web browser to locate and access a web site.

27. The system of claim 26, wherein movable means dragable.

28. The system of claim 26, wherein the dialog box structure is a three-part dialog box structure.

29. Computer software using a personal computer coupled to a global communications network, said personal computer having an operating system enabling a web browser to locate and access a web site, wherein the computer software allows the personal computer to aesthetically create and allow access in an aesthetically appealing way to a personal portal screen of icons having links to as many favorite web sites as is desired, said personal computer interacting with a system computer that maintains a system web site accessible by the personal computer, said system computer receiving mail from advertisers, said computer software comprising:
a. display structure for displaying to a user a personal portal screen of visual images that are movable across a computer screen, said display structure including access structure for a user at a web site of the system computer to access a blank personal portal screen by downloading a system software that includes a system toolbar;
b. icon generator structure for generating icons that function as links to favorite web sites, said icon generating structure including an icon generating button and including a visual cue button that signals to a user whether a visited web site is a merchant partner;
c. visual cue structure that displays a visual cue on the system toolbar to indicate whether a visited web site is a merchant partner or a non-merchant partner;
d. dialog box structure for creating icons associated with visited web sites owned by non-merchant partners, said dialog box structure including topic selection substructure for opening up a first selection window of topics and selecting a topic from the first selection window, visual image selection substructure for opening up a second selection window of visual images and selecting a visual image from the second selection window, and naming substructure for naming the favorite web site after being prompted to do so;
e. confirmation structure for confirming the selection of the topic, visual image and name, after being prompted to do so and transmitting the selected visual image and name to the system computer, forming a basis for the personal portal screen displayed on the personal computer, wherein the selected visual image functions as a link to the favorite web site.

30. The system of claim 29, wherein connected to a selected visual image of a merchant partner is a link mail structure that can receive marketing information in a form of a link mail sent from the favorite web site and can display said link mail when a cursor is placed over the selected visual image.

31. The system of claim 30, wherein the link mail structure has notification structure to notify a user that said link mail structure received a link mail, said notification structure displaying a small visual symbol and wherein the link mail structure can receive updated marketing information periodically.

32. The system of claim 31, wherein the link mail structure can display the marketing information in a link mail in an expanded format and can forward the link marketing information to another address on the Internet

33. The system of claim 29, wherein the dialog box structure is a three-part dialog box structure.

34. The system of claim 29, wherein said system also includes transmission structure for transmitting an advertising banner for a favorite advertised web site to the personal portal screen when a user clicks on and drags the advertising banner located on a visited web site to the personal portal screen wherein the advertising banner functions as a link to the favorite advertised web site.

35. The system of claim 34, wherein the transmission structure includes advertising strip structure for allowing banners to appear as advertisements in a designated strip of space on the personal portal screen and includes advertiser logo transfer structure for transferring advertisers'logos located in the designated strip to a portion of the personal portal screen containing the icons that function as links to favorite web sites and favorite advertising web sites.

36. The system of claim 34, wherein connected to the selected visual image is a link mail structure that can receive marketing information in a form of a link mail sent from the favorite web site of a merchant partner and can display said link mail when a cursor is placed over the selected visual image.

37. The system of claim 36, wherein the link mail structure has notification structure to notify a user that said link mail structure received a link mail, said notification structure displaying a small visual symbol, and wherein the link mail structure can receive updated marketing information periodically.

38. The system of claim 36, wherein the link mail structure can display the marketing information in a link mail in an expanded format and can forward the link marketing information to another address on the Internet.

39. The system of claim 34, wherein the dialog box structure is a three-part dialog box structure.
